(19) United States
(12) Patent Application Publication
(10) Pub. No.: US 2008/0178140 A1
(43) Pub. Date: Jul. 24, 2008

(54) METHOD FOR CORRECTING PHOTOMASK PATTERN

(75) Inventors: Ling-Chieh Lin, Taichung County (TW); Chuen-Huei Yang, Taipei City (TW); Chien-Fu Lee, Taipei City (TW); I-Hsiung Huang, Hsinchu County (TW)

Correspondence Address: J C PATENTS, INC., 4 VENTURE, SUITE 250, IRVINE, CA, 92618, US

(73) Assignee: UNITED MICROELECTRONICS CORP., Hsinchu (TW)

(21) Appl. No.: 11/624,544

(22) Filed: Jan. 18, 2007

(51) Int. Cl. G06F 17/50

(52) U.S. Cl. 716/19

(57) ABSTRACT

A method for correcting a photomask pattern is disclosed. The correction method determines a layout condition according to the space and line width of a layout pattern. The layout condition is used to determine the type of optical proximity correction to be used for a layout pattern in order to generate a correction pattern, and the correction pattern is compared with a predetermined specification. Furthermore, a modified-rule optical proximity correction table is employed to correct the special layout pattern. Therefore, the fidelity correction may be easily implemented.

### BACKGROUND OF THE INVENTION

1. Field of the Invention

The present invention relates to a method for correcting a photomask pattern. More particularly, the present invention relates to a hybrid method for correcting a photomask pattern.

2. Description of Related Art

Nowadays, with the development of the integrated circuit (IC), element downsizing and integration is an essential trend, and is also an important topic for each industry to actively develop. In the whole semiconductor process, lithography may be referred to as one of the most important steps. Therefore, the fidelity of transferring the photomask pattern to the wafer is quite important. If the transferring of the pattern is not correct, the tolerance of the critical dimension (CD) on the chip may be affected, and the resolution of the exposure may be reduced.

The integration is gradually improved and the size of the element is gradually reduced, the distance between the elements must be reduced, therefore, in the lithography process, deviations in the transferring of the pattern may be generated, i.e. the so-called optical proximity effect (OPE). OPE may occur when the light beam is projected on the chip through the pattern on the photomask, in one aspect, the light beam is expanded due to scattering of the light beam, and in another aspect, the light beam may pass through the photoresist layer of the chip surface and may get reflected back by the semiconductive substrate of the chip.

The optical proximity correction (OPC) is directed to eliminate the CD deviation because of the proximity effect. In the conventional OPC method, the line width of the original pattern which intends to be exposed on the semiconductor substrate of the chip is reduced or increased so as to make the line widths of the patterns exposed from the dense pattern region and the isolation pattern region maintain the same. FIG. 1 is a flow chart of a conventional hybrid OPC method. Referring to FIG. 1, first, a layout file is received, and the layout file is used to describe the geometric shape of the IC layout pattern, i.e. the original pattern to be transferred (step 101). Next, a Boolean logic operation is used to convert the layout into a suitable format (step 103). Next, the hybrid OPC is used to perform correction on the layout pattern (step 105). In other words, a model-based OPC (step 107) or a rule-based OPC (step 109) is selected to correct the layout pattern. Finally, after the correction is completed (step 111), the corrected layout pattern is sent to the photomask factory, so as to carry out the subsequent processes.

In the conventional method, usually, the correction method is determined according to the pitch of the layout pattern, and a same layout region only uses an OPC to correct. Therefore, the model-based OPC is not suitable for correcting the isolation pattern region when the layout pattern is an asymmetric layout; the model-based OPC is not suitable for correcting the isolation pattern region. As for the rule-based OPC, the correction result is close to the original pattern and is not suitable for dense pattern region.

### SUMMARY OF THE INVENTION

Accordingly, the present invention is directed to a method for correcting a photomask pattern, which uses a hybrid OPC and includes a modified-rule OPE correction table. The method of the present invention is capable of quickly and accurately correcting the layout pattern if special, layout pattern occurs.

The present invention is also directed to a method for correcting a photomask pattern including using a model-based OPC; and using a rule-based OPC when the correction result using the model-based OPC is not desired. Thus, the fidelity correction may be effectively accelerated.

The present invention is also directed to providing a method for correcting a photomask pattern including using a rule-based OPC first; and using a model-based OPC when the correction result using the rule-based OPC is not desired. Thus, the fidelity correction may be effectively accelerated.

According to an embodiment of the present invention, the method for correcting a photomask pattern includes receiving a layout corresponding to a layout pattern; selecting an OPC according to the layout condition of the layout pattern to correct the layout pattern; generating a first correction pattern if a first OPC is selected to correct the layout pattern and comparing the first correction pattern with a predetermined specification, wherein if the first correction pattern does not conform to the predetermined specification, a second OPC is used to correct the layout pattern to generate a second correction pattern.

According to an embodiment of the present invention, the layout pattern may be corrected according to a modified-rule optical proximity correction table if the second correction pattern does not conform to the predetermined specification, and wherein the modified-rule optical proximity correction table comprises a plurality of groups of correction rules for special layout conditions.

According to an embodiment of the present invention, if the first OPC is a model-based OPC, the second OPC is a rule-based OPC.

According to an embodiment of the present invention, if the second OPC is a model-based OPC, the first OPC is a rule-based OPC.

According to an embodiment of the present invention, the step of selecting an OPC according to the layout condition of the layout pattern to correct the layout pattern comprises using a hybrid optical correction method to select the first OPC or the second OPC.

The present invention also provides another method for correcting a photomask pattern, which comprises receiving a layout corresponding to a layout pattern first; using a model-based OPC to correct the layout pattern and generating a first correction pattern according to the layout condition of the layout pattern; comparing the first correction pattern with a predetermined specification, and using a rule-based OPC to generate a second correction pattern when the first correction pattern does not conform to the predetermined specification.

According to an embodiment of the present invention, if the second correction pattern also does not conform to the predetermined specification, the layout pattern is corrected according to the modified-rule optical proximity correction table, wherein the modified-rule optical proximity correction table comprises a plurality of groups of correcting rules for special layout condition.

The present invention provides another method for correcting a photomask pattern, which comprises receiving a layout corresponding to a layout pattern first; using a rule-based OPC to correct the layout pattern and generating a second correction pattern according to the layout condition of the layout pattern; comparing the second correction pattern with a predetermined specification, and using a model-based OPC to correct the layout pattern to generate a first correction pattern when the second correction pattern does not conform to the predetermined specification.

According to an embodiment of the present invention, wherein if the first correction pattern does not conform to the predetermined specification, the layout pattern is corrected according to the modified-rule optical proximity correction table. The modified-rule optical proximity correction table has a plurality of groups of correcting rules for special layout condition.

According to an embodiment of the present invention, the step of receiving the layout comprises performing a Boolean logic operation on the layout pattern to convert the format of the layout pattern.

According to an embodiment of the present invention, the layout condition of the layout pattern comprises a layout width and a layout space etc.

According to an embodiment of the present invention, a layout condition is determined according to the space and the width of the layout pattern, and the rule-based OPC or the model-based OPC is determined according to the layout condition to perform the correcting of the layout pattern. A predetermined specification is used to compare with the correction pattern. Furthermore, in the present invention, a modified-rule OPE correction table is used to correct the special layout pattern, particularly for the asymmetric layout pattern and the special region with larger mask error enhance factor (MEEF) in the model-cased OPC.

In order to the make aforementioned and other objects, features and advantages of the present invention comprehensible, a preferred embodiment accompanied with figures are described in detail below.

### BRIEF DESCRIPTION OF THE DRAWINGS

FIG. 1 is a flow chart of a conventional hybrid OPC.

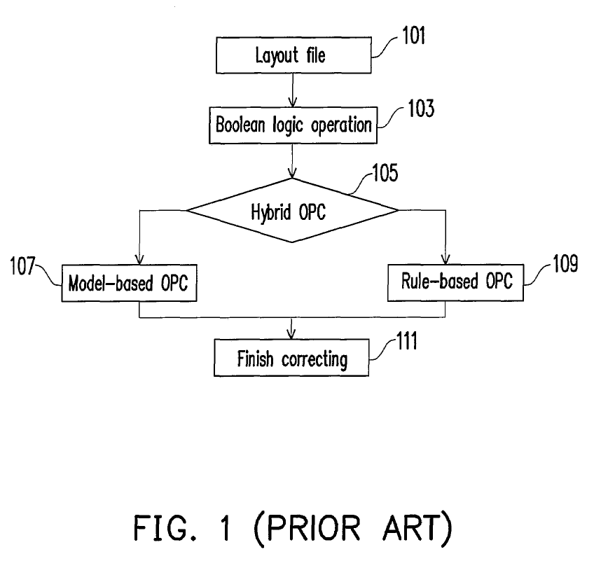

FIG. 2A is a flow chart of a hybrid OPC according to an embodiment of the present invention.

FIG. 2B is a flow chart of a hybrid OPC according to another embodiment of the present invention.

FIG. 2C is a flow chart of a hybrid OPC according to yet another embodiment of the present invention.

FIG. 3 is a schematic view of a rule-based OPC according to another embodiment of the present invention.

FIG. 4 is a flow chart of a module-based OPC according to another embodiment of the present invention.

FIG. 5 is a curve fitting schematic view of a model-base OPC according to an embodiment of the present invention.

FIG. 6 is a schematic view of the error of the model-base OPC according to an embodiment of the present invention.

FIG. 7 is a schematic view of an asymmetric layout pattern according to an embodiment of the present invention.

### DESCRIPTION OF EMBODIMENTS

Because the size of the element becomes increasingly small, during the lithography step, deviation may occur during the transfer of the layout pattern, for example, the right angle part is blunted, the tail end of the pattern is shrunken, and the line width is reduced or increased etc. Accordingly, the present invention determines type of OPC to be used according to the pitch of the layout pattern. In order to make the content of the present invention be more understandable, the embodiments are described as follows to serve as the examples according to which the present invention may surely implement.

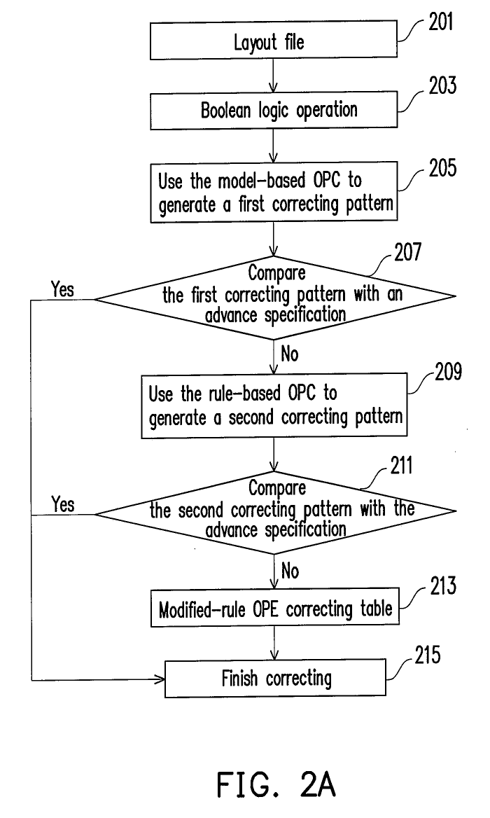

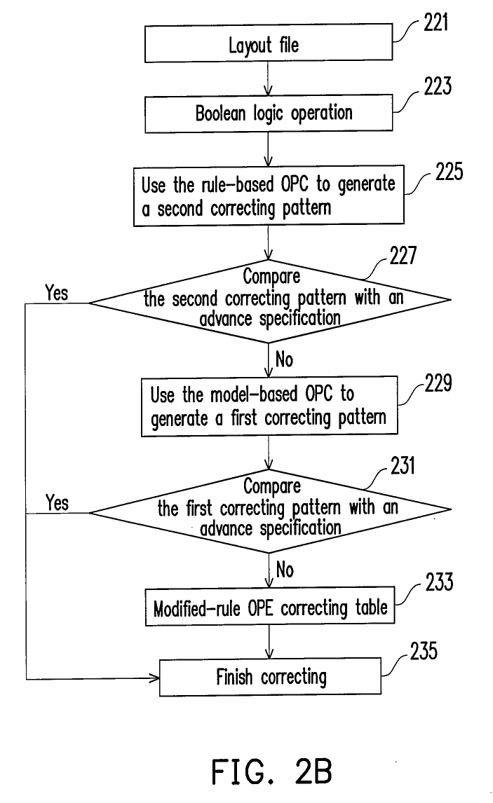

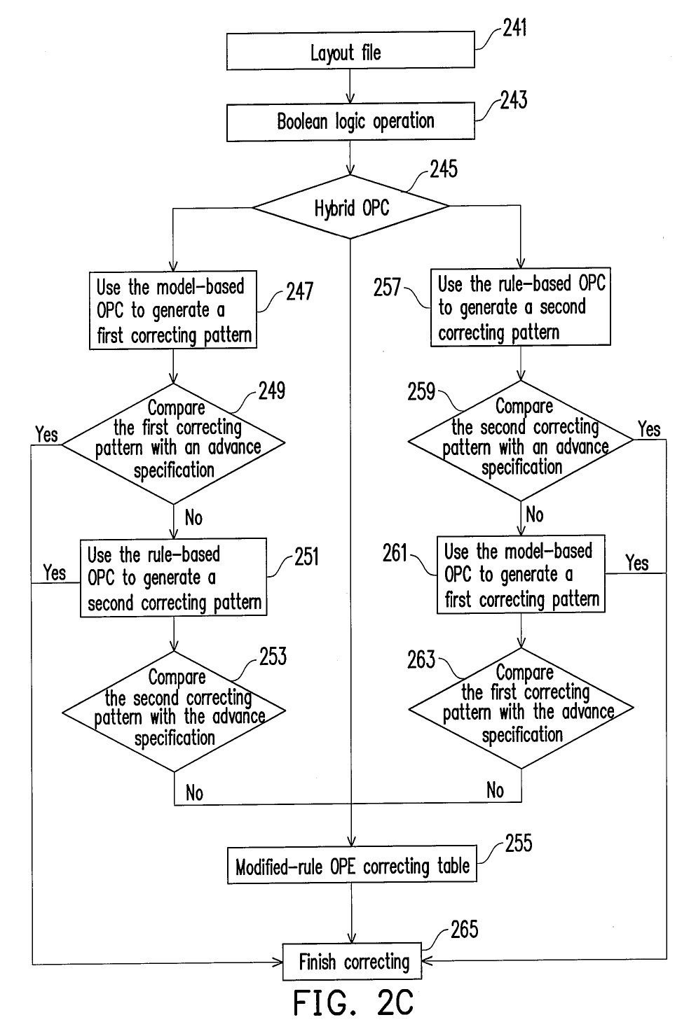

FIG. 2A is a flow chart of a hybrid OPC according to an embodiment of the present invention. Referring to FIG. 2A, first, a layout file is received (step 201), wherein the layout file is used to describe the geometric shape of the IC layout pattern, i.e. the original pattern to be transferred. Next, a Boolean logic operation is used to convert the layout file into a suitable format (step 203). Next, a model-based OPC (step 205) is used to perform the correction on the layout pattern. The model-based OPC includes obtaining a mathematical equation with a curve conforming to the method according to the layout condition of the layout pattern and the experimental result, and using the equation to correspondingly correct the layout pattern, so as to generate a relatively precise transfer of pattern. In step 205, the model-based OPC is used to generate a first correction pattern.

Next, the first correction pattern is compared with a predetermined specification (step 207), wherein the predetermined specification is determined according to different process specifications (e.g. 90 nm and 45 nm etc.), customer requirements, type of product (e.g. analog circuit or digital circuit), and the error tolerance value after development etc. After the comparison step is completed, the correction is deemed complete when the first correction pattern conforms to the predetermined specification (step 215). On the contrary, when the first correction pattern does not conform to the predetermined specification, the method is automatically switched to the rule-based OPC, according to the layout condition of the layout pattern such as the layout width and the layout space, the correction is performed by reading the correction rule quantity at the corresponding position of the rule table to generate a second correction pattern.

Next, the second correction pattern is compared with the predetermined specification to inspect whether the second correction pattern conforms to the predetermined specification (step 211). If the second correction patterned accords with the specification, the correcting is finished (step 215). On the contrary, if the second correction pattern does not conforms to the predetermined specification, a modified-rule OPE correction table is adopted (step 213), and the special layout pattern is corrected according to the correction table.

It should be noted that the step 213 is generated for a special layout pattern, when the model-based OPC cannot correctly correct the special layout pattern, and the rule-based OPC also cannot correctly correct the special layout pattern, the modified-rule OPE correction table is used to perform the correcting of the layout pattern. The modified-rule OPE correction table has a plurality of groups of correcting rules with special conditions, and it may be obtained from experiments or empirical data. In other words, for the correcting rule under the special layout condition, the so-called special layout condition is, for example, the asymmetric layout pattern, or the critical position between the dense pattern region and the isolation pattern region. In the model-based OPC, several special layout conditions exist, and larger deviation value may be generated. The above referred states may be listed as the special layout conditions, and the individually corrected rule is stored in the modified-rule OPE correction table for the pattern correcting.

In another embodiment of the present invention, the modified-rule OPE correction table also has recording and storing functions, when under the special layout condition, the most preferred correcting rule is recorded to serve as the subsequent correcting reference data. Definitely, the modified-rule OPE correction table may also be corrected by manually adding correcting. When the performed test pattern or the experimental data is more, the data of the correction table is more complete accordingly, and includes more special conditions, such that any layout patterns can be exactly corrected in the future. Finally, after the correcting is finished (step 215), the corrected layout pattern is sent to the photomask factory to perform the subsequent processes.

FIG. 2B is a flow chart of a hybrid OPC according to another embodiment of the present invention. The main difference between FIGS. 2B and 2A is that the rule-based OPC is firstly performed, if the layout pattern cannot be exactly corrected, the model-based OPC is used to correct the layout pattern. Referring to FIG. 2B, firstly a layout file is received (step 221), and then the Boolean logic operation is used to convert the layout file to the suitable format (step 223). Next, the rule-based OPC is used (step 225), according to the layout condition of the layout pattern, the correction is performed by reading the correcting rule quantity at the corresponding position of the rule table, so as to generate a second correction pattern. Then, the second correction pattern is compared with the predetermined specification (step 227). After the comparing is finished, if the second correction patterned accords with the predetermined specification, the correcting is finished (step 235). On the contrary, it is automatically switched to the model-based OPC (step 229) to perform the correction on the layout pattern, so as to generate a first correction pattern. Next, the first correction pattern is compared with the predetermined specification to inspect whether the first correction pattern accords with the predetermined specification (step 231). If the first correction pattern accords with the specification, the correcting is finished (step 235). On the contrary, if the first correction pattern still does not conforms to the predetermined specification, the modified-rule OPE correction table is adopted (step 233), and the special layout pattern is corrected according to the correction table. The step 233 is the same as or similar to that of step 213, and therefore the description is not repeated again.

FIG. 2C is a flow chart of a hybrid OPC according to yet another embodiment of the present invention. Referring to FIG. 2C, this embodiment is a combination of the above two embodiments, the layout condition is used to determine the type of correction method to be used. Steps 241-243 are the same as or similar to steps 201-203 and steps 221-223 of the above embodiments, therefore detail description thereof is not repeated again. Next, the hybrid OPC is used to perform the correction on the layout pattern (step 245). In step 245, according to the layout condition of the layout pattern (layout space and layout width, i.e. space and width in layout), the first OPC or the second OPC is selected to correct the layout pattern. In this embodiment, the first OPC and the second OPC are respectively the model-based OPC and the rule-based OPC. Step 245 determines the condition of the hybrid correction method, that is, in a layout pattern correction process, several correction methods are involved, and the most suitable correction method may be selected according to different layout conditions.

In this embodiment, in step 245, according to the layout condition, the model-cased OPC or the rule-based OPC is selected to correct the layout pattern. The layout width (the width of the layout pattern or the line width) and the layout space (density of the patterns) correspond to the pitch of the layout pattern. In other words, the model-based OPC or the rule-based OPC may be selected according to the pitch and the layout width. If the model-based OPC is selected, the method proceeds to step 247, and if the rule-based OPC is used, the method proceeds to step 257 to correct the layout pattern.

Referring to FIG. 2C, a step of dividing value may be set in step 245, and the adopted correction method is selected according to the pitch of the layout pattern, if the pitch is under the dividing value and thus belongs to the dense pattern region, it is suitable to use the model-based OPC (step 247). Because in the dense pattern region, the peripheral environment easily affects the correcting result, the relatively exact correction is obtained by using the model-based OPC. If the pitch is above the dividing value and thus belongs to the isolation pattern region, it is suitable to use the rule-based OPC (step 257). Because the layout space and the layout width in the layout pattern are relatively loose, the preferred correction may be obtained in a relatively short time by using the rule-based OPC, and if the model-based OPC is used, the correcting time is prolonged.

In still another embodiment of the present invention, in step 245, if the layout condition of the layout pattern is the special layout condition, the modified-rule proximity effect correction table may be directed used (step 255) to correct.

In this embodiment, if according to the layout condition, in step 245, the model-based OPC is selected (step 247) to perform the correction on the layout pattern, according to the layout condition of the layout pattern, the curve fitting method is used to obtain a mathematical equation, and the equation is used to correct the layout pattern, so as to generate a first correction pattern. If it is determined that the value of the curve fitting is too different from the practical data, it is automatically switched to the rule-based OPC. Steps 247-255 are the same as or similar to steps 205-213 of the above embodiments, so they are not described here.

Moreover, according to the layout condition, if in step 245, the rule-based OPC (step 257) is selected to perform the correction on the layout pattern, according to the layout condition of the layout pattern, the correction is perform by reading the correcting rule quantity at the corresponding position of the rule table. Steps 257-263 are the same as or similar to steps 225-233 of the above embodiments, so they are not described here. Finally, after the correcting is finished (step 265), the corrected layout pattern is sent to the photomask factory to perform the subsequent processes. Therefore, in this embodiment, for the layout patterns with different layout conditions, OPC suitable for the pattern is used to correct the pattern, and for the pattern at the critical position of the layout condition, if the rule-based and the model-based OPC are not suitable, it is considered as the special pattern, and the modified-rule OPE correction table is used to perform the correction.

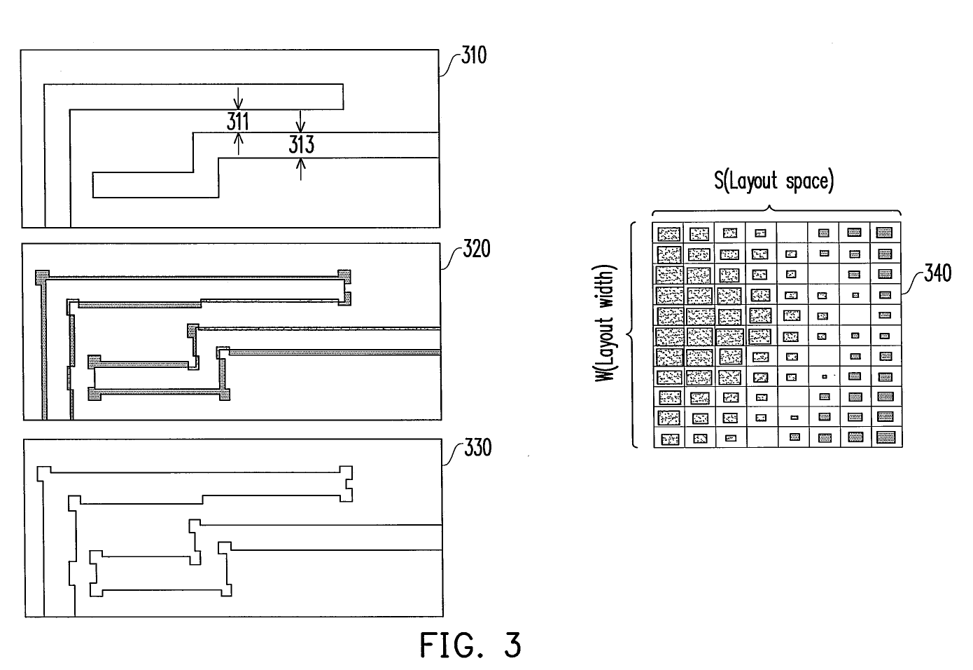

In order to express the above concept more exactly, it is illustrated with the simple drawings as follows. FIG. 3 is a schematic view of a rule-based OPC according to another embodiment of the present invention. Referring to FIG. 3, in the rule-based OPC, according to the layout width 313 and the layout space 311 of the layout pattern 310 to be corrected, the obtained correcting rule quantity in the database is used to perform correcting. In the correction method, according to an embodiment of the present invention, a rule table 340 is generated according to the experimental result, and the layout width W and the layout space S. The rule table 340 has correction rules corresponding to different layout widths and layout spaces, and the number of correction rules may be obtained by the experimental result. Next, the number of correction rules on the relative position in the rule table 340 is read according to the layout width 313 and the layout space 311 in the layout pattern 310. The layout width on the layout pattern 310 is reduced or increased according to the correction rule as shown in the layout pattern 320 to obtain a final correction pattern 330.

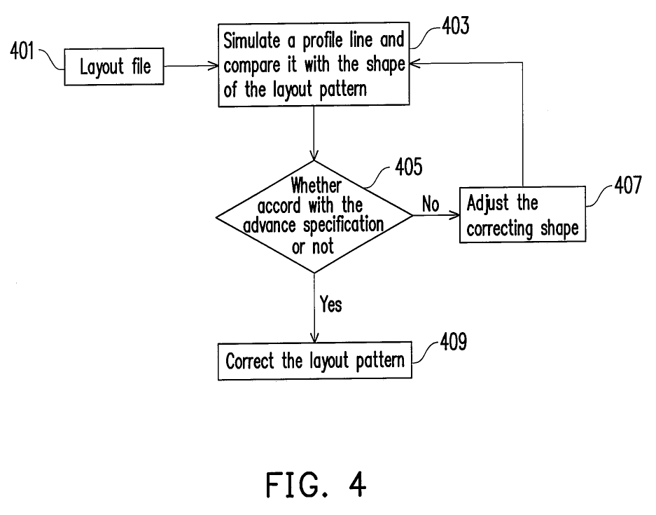

Furthermore, FIG. 4 is a flow chart of a module-based OPC according to another embodiment of the present invention. Referring to FIG. 4, when the elements of the process become increasingly small, the layout pattern is reduced and becomes more complicated, and the peripheral environment of the layout pattern may affect the exposure result. If the rule-based OPC is used continuously, error may be resulted, and therefore the model-based OPC is adopted, while the previous exposure result is used to perform a series of complicated correction calculations to generate a mathematical equation, which is used to correct the layout pattern.

Referring to FIG. 4, first, a layout pattern is input (step 401), and then a profile line of the correction pattern is simulated according to the mathematical equation obtained from the experimental result, and the profile line is compared with the shape of the layout pattern (step 403). Next, whether or not the result of comparison conforms to the predetermined specification is determined (step 405), wherein if the result conforms to the predetermined specification, the layout pattern is corrected (step 409). On the contrary, if the result does not conform to the predetermined specification, the shape of corrected layout pattern is adjusted (step 407), a profile line of the correction pattern is simulated again, and is compared with the shape of the layout pattern (step 403). Generally, steps 403 to 407 may repeatedly performed 4 to 8 times to obtain a preferred profile line.

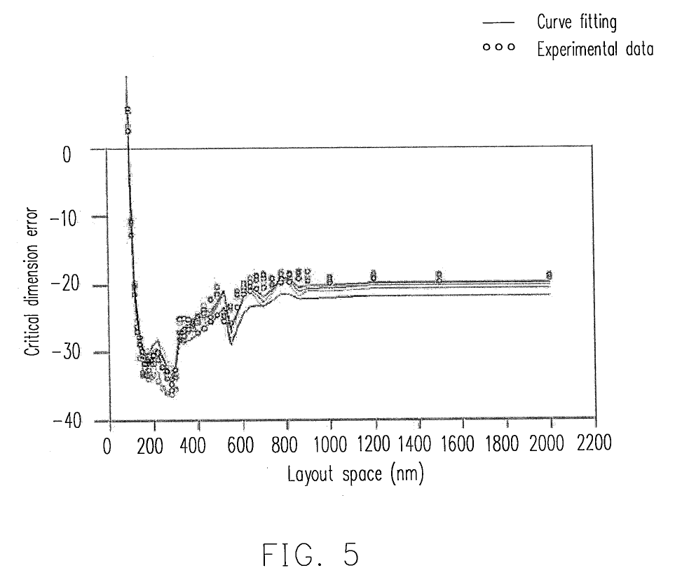

FIG. 5 is a curve fitting schematic view of a model-base OPC according to an embodiment of the present invention. Referring to FIG. 5, hollow dots represent the experimental data, and continuous lines represent the curve generated after applying the correction using the mathematical equation indicated above. As can be seen from FIG. 5, the curve generated after applying the correction is close to the experimental data indicating that the mathematical equation may be adopted by the model-based OPC. Furthermore, not all the values of the curve fitting are close to the experimental data, in the operation process, errors may be generated, for example, the experimental data and the curve fitting after approximately the layout space of 550 nm are quite different. Therefore, it may be viewed that the model-based OPC is quite suitable for correcting the dense pattern region.

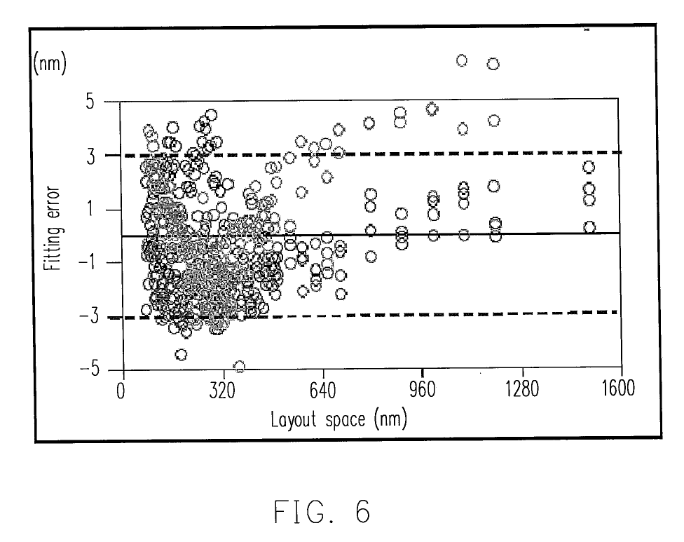

In addition, FIG. 6 is a schematic view of the error of the model-base OPC according to an embodiment of the present invention. Referring to FIG. 6, it is assumed that the error tolerance is ±3 nm, that is the layout width of the correction pattern is only allowed to increase or reduce 3 nm, and if the MEEF is 3.3, the error value is 9.9 nm (3*3.3). That is to say, if the correcting data with the MEEF of 3.3 is used to correct the layout pattern, after the corrected layout pattern is developed on the wafer, a error value of 9.9 nm is generated, exceeding the range of ±3 nm. Therefore, if the model-based OPC is used, higher error may be generated on some correction dots with big MEEF.

Furthermore, if the rule-based OPC is separately used, in the case of the asymmetric layout pattern, it is impossible to precisely correct the layout pattern, and for the 2D (dimension) layout pattern, the correcting accuracy waits to be improved. Therefore, in the present invention, the model-based OPC and the rule-based OPC are combined, and also the modified-rule OPE correction table is provided to correct the special layout pattern, e.g. asymmetric layout pattern.

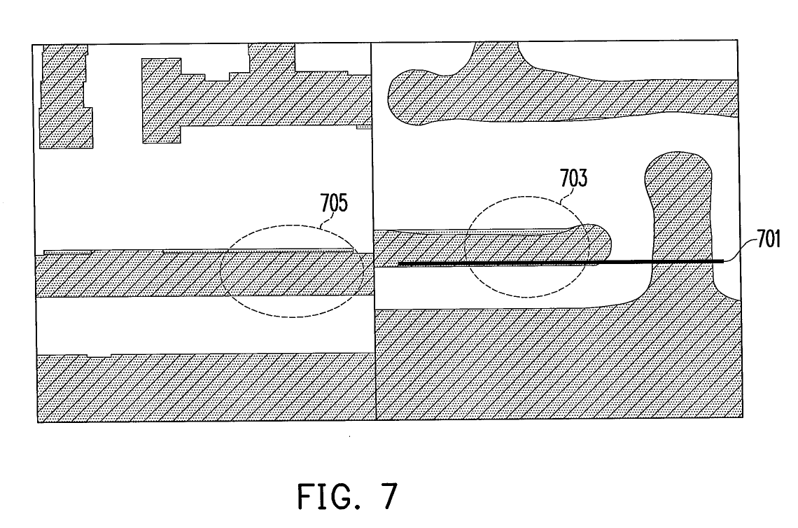

FIG. 7 is a schematic view of an asymmetric layout pattern according to an embodiment of the present invention. Referring to FIG. 7, a dividing line 701 is in the middle of the left side. According to the layout width and the layout space, the dense pattern region and the isolation pattern region are determined, because the layout space above the layout condition 701 is larger than the layout space below the layout condition 701, and therefore the pattern region above the dividing line 701 is the isolation pattern region, and the rule-based OPC is used, and because the pattern below the dividing line 701 is the dense pattern region, and therefore the model-based OPC is used. However, the correction result at the critical position 703 of the dividing line 701 is not desired, the position is considered as the special layout pattern, so the modified-rule OPE correction table is used to correct. Moreover, the critical position 705 on the left side is also considered as the special layout pattern, the modified-rule OPE correction table may also be used to correct.

It should be noted that in the present invention the layout condition of the corrected special layout pattern and the corresponding correcting rule are stored in the modified-rule OPE correction table in the database. In the future, the layout pattern with similar or same layout conditions may be corrected according to the correction table in the database.

To sum up, the method for correcting a photomask pattern of the present invention has at least the following advantages.

1. The model-based OPC is used in the dense pattern region, and the rule-based OPC is used in the isolation pattern region, the two correction methods are combined to improve the fidelity correction and also increase the correction rate.

2. When the special layout pattern occurs, and the above two correction methods cannot provide precise correction result, the modified-rule OPE correction table is used to correct. When more test patterns are performed, in the future it may be applied to a wider range on the layout pattern correction.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for correcting a photomask pattern, comprising:
receiving a layout file corresponding to a layout pattern;
selecting a first optical proximity correction (OPC) or a second OPC according to a layout condition of the layout pattern to correct the layout pattern;
generating a first correction pattern when the first OPC is selected to correct the layout pattern; and
comparing the first correction pattern with an predetermined specification, wherein when the first correction pattern does not conform to the predetermined specification, the second OPC is used to correct the layout pattern to generate a second correction pattern.

2. The method for correcting a photomask pattern as claimed in claim 1, further comprising:
correcting the layout pattern according to a modified-rule optical proximity correction table when the second correction pattern does not conform to the predetermined specification, wherein the modified-rule optical proximity correction table has a plurality of groups of correcting rules for special layout conditions.

3. The method for correcting a photomask pattern as claimed in claim 1, wherein the step of receiving the layout file further comprises:
performing a Boolean logic operation on the layout pattern to convert a format of the layout pattern.

4. The method for correcting a photomask pattern as claimed in claim 1, wherein the first OPC is a model-based OPC, and the second OPC is a rule-based OPC.

5. The method for correcting a photomask pattern as claimed in claim 1, wherein the second OPC is a model-based OPC, and the first OPC is a rule-based OPC.

6. The method for correcting a photomask pattern as claimed in claim 1, wherein the layout condition of the layout pattern comprises a layout width and a layout space.

7. The method for correcting a photomask pattern as claimed in claim 1, wherein in the step of selecting one of the first OPC and the second OPC according to the layout condition of the layout pattern to correct the layout pattern, a hybrid optical correction method is used to select the first OPC or the second OPC.

8. The method for correcting a photomask pattern as claimed in claim 1, wherein in the step of selecting one of the first OPC and the second OPC according to the layout condition of the layout pattern to correct the layout pattern, a modified-rule optical proximity correction table is selected according to the layout condition of the layout pattern to correct the layout pattern.

9. A method for correcting a photomask pattern, comprising:
receiving a layout file corresponding to a layout pattern;
using a model-based OPC to correct the layout pattern and generate a first correction pattern according to a layout condition of the layout pattern; and
comparing the first correction pattern with a predetermined specification, wherein if the first correction pattern does not conform to the predetermined specification, a rule-based OPC is used to generate a second correction pattern.

10. The method for correcting a photomask pattern as claimed in claim 9, further comprising:
correcting the layout pattern according to a modified-rule optical proximity correction table when the second correction pattern does not conform to the predetermined specification, wherein the modified-rule optical proximity correction table has a plurality of groups of correction rules for special layout condition.

11. The method for correcting a photomask pattern as claimed in claim 9, wherein the step of receiving the layout file further comprises:
performing a Boolean logic operation on the layout pattern to convert a format of the layout pattern.

12. The method for correcting a photomask pattern as claimed in claim 9, wherein the layout condition of the layout pattern comprises a layout width and a layout space.

13. A method for correcting a photomask pattern, comprising:
receiving a layout file corresponding to a layout pattern;
using a rule-based OPC to correct the layout pattern and generate a second correction pattern according to the layout condition of the layout pattern; and
comparing the second correction pattern with a predetermined specification when the second correction pattern does not conform to the predetermined specification, and using a model-based OPC to correct the layout pattern to generate a first correction pattern.

14. The method for correcting a photomask pattern as claimed in claim 13, further comprising:
correcting the layout pattern according to a modified-rule optical proximity correction table when the first correction pattern does not conform to the predetermined specification, wherein the modified-rule optical proximity correction table has a plurality of groups of correction rules for special layout condition.

15. The method for correcting a photomask pattern as claimed in claim 13, wherein the step of receiving the layout file further comprises:
performing a Boolean logic operation on the layout pattern to convert the file format of the layout pattern.

16. The method for correcting a photomask pattern as claimed in claim 13, wherein the layout condition of the layout pattern comprises a layout width and a layout space.
